(19) United States
(12) Patent Application Publication
(10) Pub. No.: US 2012/0187100 A1
(43) Pub. Date: Jul. 26, 2012

(54) Heated Digit Cot

(76) Inventor: Julius Sterner, Akron, OH (US)

(21) Appl. No.: 13/323,003

(22) Filed: Dec. 12, 2011

Related U.S. Application Data
(60) Provisional application No. 61/435,408, filed on Jan. 24, 2011.

(51) Int. Cl. H05B 3/02

(52) U.S. Cl. 219/211

(57) ABSTRACT

A finger cot device for the treatment of injured or poorly circulating digits is described. The device includes an integrated heating coil powered by an internal battery that may be controlled with an on/off switch. The finger cot may be held on the injured digit using a hook and loop fastener capable of securing the device to any size digit. Further, the device may be manufactured in a variety of thicknesses, allowing thicker, more rigid cots to be used when the injured digit requires support or thinner cots that are more flexible when manual dexterity is needed. Increased circulation, muscle relaxation and warmth are provided to the user, which is particularly helpful for the elderly, those with finger injuries or partially amputated digits. In an alternate embodiment, a solar array is provided to recharge the internal battery.

### CROSS REFERENCE TO RELATED APPLICATION

This application claims the benefit of U.S. Provisional Application No. 61/435,408 filed on Jan. 24, 2011, entitled “Heated Finger Cot.”

### BACKGROUND OF THE INVENTION

1. Field of the Invention

The present invention relates to a device for improving the feeling, movement and temperature of a digit, such as a finger or toe. More specifically, the present invention can be placed over a digit to improve circulation and temperature regulation.

2. Description of the Prior Art

Certain conditions, illnesses or events can cause an individual to lose feeling, movement, or warmth in their fingers. These events can be sudden, such as a sports injury or surgical procedure, or occur over time given a specific illness or decline in health. These effects are a common symptom of poor circulation to the extremities, notably the fingers and toes. Individuals have been known to wear gloves or mittens in an attempt to counteract these effects and warm their fingers, but this reduce an individual's ability to participate in common activities that require manual dexterity, such as operating a phone, turning pages, or any similar dexterous activity. Further, the use of gloves may not provide adequate warmth to stimulate dexterity, promote free movement and improve circulation. Therefore an effective solution is necessary to address a clear need for a finger warming device.

Several applications have published and patents have been granted related to devices that attempt to warm a user's hands and digits thereon. These prior art devices have several known drawbacks inherent in their design that limit their usefulness in restoring circulation, movement and feeling back into a digit of a user. They further do not address the issue of an injured or circulation-deficient digit requiring heat to restore sensation. The present invention provides a finger covering with an imbedded heat source that introduces thermal therapy individually and in close proximity to an affected digit.

Included in the similar prior art are applications for restoring circulation using a medical splint device. U.S. Patent Publication No. 2010/0234785 to Liebowitz describes a medical device comprising a sheath that fits around at least a portion of the circumference of a finger. Additionally, the sheath may comprise a pouch for retaining an insert, supporting and protecting the finger. The Liebowitz invention exemplifies a medical-style splint support device that addresses a different issue than that of the present invention. While the splint may provide stability and alternatively a heat producing fabric or pouch for a thermal insert, no mention is made of a finger covering with an imbedded heat source for promoting circulation, muscle relaxation and improved feeling. The splint device is provided for the recovery of one suffering from an injury or surgical procedure. The present invention is designed to provide heat from a digit cot to induce improved circulation.

Several other patents have issued describing heated gloves. In particularly these devices have focused on heating a user's hands sufficiently to allow certain tasks to be performed in the cold. Yates U.S. Pat. No. 5,509,143 describes a heated glove that includes a cap portion pivotally connected by stitching to a hand portion to cover the user's fingers, which project from an end of the hand portion. The cap portion further contains a pocket for insertion of a pervious pouch containing an oxygen-activated heating chemical. The stitching arrangement is such that the user may simply manipulate the fingers of a single hand to pivot the cap portion associated therewith rearwardly to uncover the fingers.

Similarly, Gadd U.S. Pat. No. 5,541,388 describes a heated glove that includes a heating wire woven into the fabric of the back of the glove, extending to the distal end of the thumb and finger portions of the glove. The wire connects to an electrical power source to cause the wire to become warm when activated. In one embodiment of the glove, the distal ends of the thumb and finger portions are truncated and have fabric flaps extending from the backside of the finger portions that may be folded over the fingertips as desired by the user. Each flap has the heating wire extending therein to heat the flap. A releasable fastener attaches to the back of the flap to permit securing of the flap in a position folded against the back of the thumb and finger portions. A metal finger pick includes an electrical connector that corresponds with an electrical connector on the flap that is electrically connected to the heating wire, to permit heating of the pick when placed on the finger. Additionally, Helenick U.S. Pat. No. 6,141,801 describes a thermal glove fitted to a human hand having integrated within the body a thermal, gel-filled pack. The gel pack includes a sealed bladder constructed of flexible, durable material resistant to heat and rupture. The bladder encloses a thermal gel adapted for repeated heating and cooling, such as by microwave exposure or refrigeration. The gel retains and transmits heat energy or cold to the hand of a wearer and is repeatably rechargeable in either the heat or the cold. In preferred aspects of the invention, the gel pack is removeably placed within a pocket integrated within the body of glove.

The Yates, Gadd and Helenick patents describe devices that function as heated gloves to allow manual dexterity required to perform certain activities when the user's hands are cold. These inventions, while providing novel ways to warm a user's hands, do not focus on the need addressed by the present invention. These devices are bulky and cover the entire hand region. They are adapted for use in cold weather climates, and are further unattractive, unappealing and lack usefulness in an everyday environment wherein a user requires heat therapy. The present invention provides a heated cot that is applicable in all situations, provides a means of heat conveyance with reduced visual signature and allows a user to selectively apply the cot to a particular finger or set of fingers. Use of the present invention does not limit one's ability to conduct normal activity, as the length, thickness and therefore the obtrusiveness of the cot can be tailored for a specific need and a user's situation.

There is currently a need in the art for a device to assist in the heating and circulation of a single digit that is either injured or suffering from poor circulation. Its structure and intent substantially diverges in design elements from the prior art and consequently it is clear that there is a need for an improved digit warming device. In this regard the instant invention substantially fulfills these needs.

### SUMMARY OF THE INVENTION

In view of the foregoing disadvantages inherent in the known types of heated hand devices now present in the prior art, the present invention provides a new digit heating device wherein the same can be utilized for providing convenience for the user when an injured or circulation-deficient digit requires heat to improve feeling, mobility, circulation and warmth.

The present invention provides heat therapy to a finger of a user to promote finger dexterity, blood circulation, and comfort. The device comprises a sheath of material with an imbedded heat source and power supply. The device resembles a standard finger cot, with the addition of an internal heating source that may be powered by a battery, and alternatively a solar power recharging source. The device is easily applied over the chosen finger and activated using an on/off power switch button. The device allows individuals not only to warm their fingers, but to also promote improved movement, flexibility and dexterity in a damaged finger or finger with poor circulation. Individuals with reduced functionality in their fingers or those who have difficulty retaining warmth in their digits will be provided a benefit from the present invention. The structure of the device is adaptable for use with different sized digits, allowing for smaller or larger individuals, male and female versions, partially amputated sizes and those that are adapted for use on an individual's toes.

It is therefore an object of the present invention to provide a heat therapy cot that provides thermal warming to improve circulation in a user's digit, as well as one that can aid in the treatment of an injured or affected digit.

Another object of the present invention is to provide a user with improved manual dexterity required to perform intricate tasks with an affected digit.

Yet another object of the present invention is to provide a finger heat therapy device with an internal heating element, an electrical power supply and connections therefrom, along with an embodiment that incorporates an alternate power source such as solar power.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after referring to the following description, taken in connection with the accompanying drawings.

FIG. 1 is a perspective view of the present invention, wherein an electrically heated finger cot is provided, along with a closure means for securing the device to a user's finger.

FIG. 2 is a perspective view of the present invention in a working position, slid over the outer surface of a user's finger for providing heat therapy thereto.

### DETAILED DESCRIPTION OF THE INVENTION

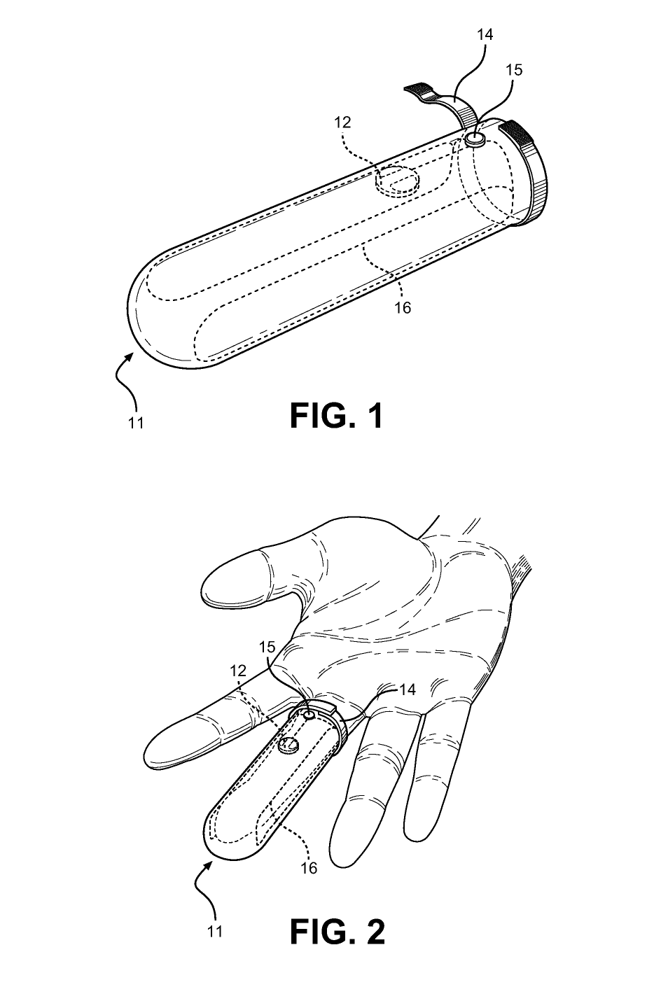

Referring now to FIG. 1, there is shown a perspective view of the present invention, wherein a finger sheath forming a finger cot 11 is provided. The cot 11 is adapted to fit snuggly over a user's finger and provide uniform heat therapy thereto. An internal circuit comprising a battery power source 12, heating coils 16, and an on/off switch 15 provide a means for supplying heat to the finger while in use. The heating coils 16 provide resistance to current flowing therethrough, inducing heat conduction through the finger cot 11 material and into the user's finger. The cot material may include a thermally insulative outer layer to prevent heat dissipation through the outer surface of the cot 11 and to improve heat retention into the user's digit as heat is not allowed easily escape. The material may further comprise a flame retardant material to prevent injury to the user in the event of a coil overheating. The on/off switch 15 controls the flow of current from the battery 12 to the heating coils 16, which controls the operation of the device.

While in use, the finger cot provides a sheath covering that is secured at its base using a securing strap means 14. The securing strap 14 is preferably a strip of hook and loop fasteners, which allows the strap to securely conform the opening of the cot 11 around the base of the user's finger during operation. A snug fit and a secure attachment are ideal for a user wishing to utilize the present invention with minimal detraction or interference with normal activity. A snug fit provides the user with the ability to manipulate objects with their finger as they would normally, while the induced heat therapy loosens tissue, improves blood flow and warms the digit for improved tactile sensitivity.

The arrangement of the internal electric circuit, namely the arrangement and position of the battery power supply 12 and the heating coils 16 may vary depending on the application, the size of the cot 11 and the ability of the coils 16 to conduct a uniform distribution of heat into the cot 11 and into the user's finger. Referring to FIG. 1, there is shown an embodiment of the heating coil 16 arrangement that provides equal heating from the lateral sides of the cot 11, while providing minimal resistance to the operation of the finger (i.e. minimal resistance to joint movement through finger flexion and extension). The coil 16 may be intricately woven through the cot 16 to increase surface area coverage, however this increases the length of coil 16 utilized in a particular cot 11, the quantity of electrical resistance and therefore the size of the battery, and finally the ability of the cot 11 to flex and bend. The coil 16 provided within the cot 11 is an electrically conductive and Joule heating wire, whereby electric current is passed through the coil conductor to release heat. The thickness, position and length of coil 16 utilized in the cot is dependent upon final application and end user requirements. Similarly, it is not desired to limit the structure and arrangement of the imbedded electric circuit used to provide heat therapy. Any circuit that includes a battery power source 12, an on/off control switch 15 and heating coils 16 may be utilized for the present invention. The present invention does not limit the circuit design to a parallel or series circuit, or one that includes a specific coil or setup.

Referring now to FIG. 2, there is shown a perspective view of the present invention in a working position, situated on a digit of a user to provide heat therapy thereto. The cot 11 is secured to the affected, injured or poorly circulating digit using the securing strap means 14 at its base, while the surface of the cot 16 is tailored to fit snugly against the user's skin and provide a minimally intrusive therapy device. The cot 11 structure comprises a cylindrical sheath with a first closed end positioned at the tip of the user's digit, opposed by a second, opened end that is secured to the base of the digit using a securing strap means 14. The first end may alternatively be open for use as a cylindrical sheath covering with free access to a user finger tip for tactile feedback during normal activity. The dimensions of the cot 11 may be tailored to meet a particular user's digit size, including the cot 11 length and diameter. This allows a conformed fit for users of different geometry, gender and medical situation. Partially amputated digits are particularly vulnerable to poor circulation and movement, and therefore would greatly benefit from a device described by the present invention. Appropriate sizing of cot 11 is required for this condition, along with different sized users, for effective application of heat therapy.

The intensity of the heat therapy may be controllable or set to a specific level for a particular cot 11, depending upon end user preferences. The preferred embodiment of the present invention has a set heat level provided by the coils 16, which can be regulated using the supplied on/off switch 15. In an alternative embodiment, a potentiometer or similar electronic control device may be imbedded within the electric circuit of the cot 11, wherein the current flowing through the coils 16 is varied depending upon user desire and needs. If more intense heat is requested, the current is increased, and vice versa.

To prolong the battery power source 12, and therefore the use of the present invention over a longer period of time, a small solar array may be included along the top surface of the cot 11. Similar to a wrist watch solar array, photovoltaic power is derived through absorption of solar radiation and conversion into electrical current, which can be fed into the battery to reduce the draining of power therefrom. The size of the array may be dependent upon the size of the cot 11, and therefore may not indefinitely power the battery 15 as required. However, the array may provide a power offset means that reduces the battery 15 drain, and therefore extends the life of a particular battery 11. This may be of particular importance if heat therapy is required in a situation where replacement batteries 12 are not readily available.

In use, the present invention provides a sheath covering designed to fit over a single finger or toe, and provide warmth through its insulative properties and through operation of imbedded heating coils 16. The heat therapy promotes dexterity, improved flexibility and movement, blood circulation, comfort, pain relief and tactile sensation. An individual slides the cot 11 over an affected finger or toe and tightens the strap closure means 14 to secure the device thereto. The size of the cot 11 should be chosen to provide a snug fit with regard to interface between the cot 11 inner surface and the surface of the user's digit. Control of the heating coils 16 is provided by the on/off control switch 14 and optionally by a variable intensity controller. As noted, the device may be made of a variety of materials, including an insulative material, a soft material for improved comfort or one that allows tactile sensation through the tip of the cot 11 during use. Thicker, more rigid materials may be used for situations where a brace is required to support an injured digit. Alternatively, thinner and more flexible materials may be used to construct cots usable during manual activities requiring dexterity. Materials that are more durable may be chosen for re-usable devices, while less usable materials used for disposable forms.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A heat therapy device for treatment of a user digit, comprising:
a cylindrical sheath forming a digit cot with a first and second end;
a securing means positioned at said second end for securing said cot to said digit;
an imbedded heating element positioned within said cot;
said heating element provided electrical power via a battery power supply and an on/off control switch.

2) A device as in claim 1, wherein said cot comprises a first closed end adapted to conform around said digit tip and an open second end adapted to conform to said digit base.

3) A device as in claim 1, wherein said cot comprises a first open end and a second open end adapted to conform to a digit and form a cylindrical sheath.

4) A device as in claim 1, wherein said sheath is adapted to fit snugly against said digit.

5) A device as in claim 1, further comprising a heat intensity control device for regulating current flowing through said heating coils.

6) A device as in claim 1, wherein said securing means comprises a hook and loop closure strap.

7) A device as in claim 1, further comprising a photovoltaic array for providing power to said battery.

8) A device as in claim 1, further comprising a cot material outer layer that is thermally insulative to prevent heat dissipation.

9) A heat therapy device for treatment of a user digit, comprising:
a cylindrical sheath forming a digit cot with a first closed end and second open end;
a securing means positioned at said second end for securing said cot to said digit;
an imbedded heating element positioned within said cot;
said heating element provided electrical power via a battery power supply and an on/off control switch.

10) A device as in claim 9, wherein said sheath is adapted to fit snugly against said digit.

11) A device as in claim 9, further comprising a heat intensity control device for regulating current flowing through said heating coils.

12) A device as in claim 9, wherein said securing means comprises a hook and loop closure strap.

13) A device as in claim 9, further comprising a photovoltaic array for providing power to said battery.

14) A device as in claim 9, further comprising a cot material outer layer that is thermally insulative to prevent heat dissipation.
